(19) United States
(12) Patent Application Publication
(10) Pub. No.: US 2010/0210434 A1
(43) Pub. Date: Aug. 19, 2010

(54) Laser Engraved Embossing Roll

(75) Inventors: Galyn A. Schulz, Greenville, WI (US); William T. Buchholz, Greenville, WI (US); Michael E. Hennes, Neenah, WI (US)

Correspondence Address: Georgia-Pacific LLC, 133 Peachtree Street NE - GA030-41, ATLANTA, GA, 30303, US

(73) Assignee: Georgia Pacific Consumer Products LP

(21) Appl. No.: 12/609,661

(22) Filed: Oct. 30, 2009

Related U.S. Application Data
(63) Continuation of application No. 10/107,415, filed on Mar. 28, 2002, now abandoned.
(60) Provisional application No. 60/279,869, filed on Mar. 29, 2001.

(51) Int. Cl. A01B 29/00

(52) U.S. Cl. 492/28

(57) ABSTRACT

The present invention is a laser engravable embossing roll exhibiting improved wear characteristics and life span through the use of an epoxy resin based material. Specifically, the embossing roll according to the present invention can be produced using standard laser engraving techniques that have heretofore been applied to rubbers. Rubber rolls, while produced significantly faster than engraved steel rolls, have the disadvantage of poor life span due to wear. The epoxy based resin rolls of the present invention overcome these disadvantages by being quickly and easily produced using laser engraving but exhibiting significantly improved wear characteristics.

This application claims the right to priority under 35 U.S.C. §119(e) based on Provisional Patent Application No. 60/279,869 filed Mar. 29, 2001.

### FIELD OF THE INVENTION

The present invention relates to an emboss roll for continuously embossing a moving web of material, such as paper. More particularly, the present invention relates to a laser engravable roll having improved wear characteristics. Still more particularly, the present invention relates to rolls that are patternable by laser engraving techniques that have improved hardness and durability. Finally, the present invention relates to an laser engraved roll made from an epoxy based resin.

### BACKGROUND OF THE INVENTION

The present invention relates to apparatus used to emboss paper products, preferably elongate webs used to make paper goods, e.g., paper towels, toilet tissue, or paper napkins. Embossing is the act of mechanically working a substrate to cause the substrate to conform under pressure to the depths and contours of a patterned embossing roll. Generally, the web is passed between a pair of emboss rolls that, under pressure, form contours within the surface of the paper.

In most configurations at least one of the two roller surfaces directly carries the pattern to be transferred to the paper web. Known configurations include rigid-to-resilient embossing and rigid-to-rigid embossing. The present invention is an improved embossing roll for use in any known embossing configuration.

In a rigid-to-resilient embossing system, a single or multi-ply substrate is passed through a nip formed between a roll whose substantially rigid surface contains the embossing pattern as a multiplicity of protuberances and/or depressions arranged into an aesthetically-pleasing manner, and a second roll, whose substantially resilient surface can be either smooth or also contain a multiplicity of protuberances and/or depressions which cooperate with the rigid surfaced patterned roll. Heretofore, rigid rolls were generally formed from a steel body which is either directly engraved upon or which can contain a hard rubber-covered surface (directly coated or sleeved) upon which the embossing pattern is laser engraved. While a steel roll that has been directly engraved has a longer lifespan, the production of a directly engraved steel roll can require a significant lead time. Known laser engraved sleeves can take less time to make but have a lifespan which is substantially less than that of a steel roll.

Resilient rolls may consist of a steel core directly coated or sleeved with a resilient material and may or may not be engraved with a pattern. If a pattern is present, it may be either a mated or a non-mated pattern with respect to the pattern carried on the rigid roll.

In the rigid-to-rigid embossing process, a single-ply or multi-ply substrate is passed through a nip formed between two substantially rigid rolls. The surfaces of both rolls contain the pattern to be embossed as a multiplicity of protuberances and/or depressions arranged into an aesthetically-pleasing manner where the protuberances and/or depression in the second roll cooperate with those patterned in the first rigid roll. The first rigid roll is generally formed from a steel body which is either directly engraved upon or which can carry a hard rubber-covered surface (directly coated or sleeved) upon which the embossing pattern is laser engraved. The second rigid roll is generally formed from a steel body which is also directly engraved upon or which can carry a hard rubber covered surface (directly coated or sleeved) upon which a matching or mated pattern is conventionally engraved or laser engraved. Laser engravable rolls are known, see for example U.S. Pat. Nos. 4,211,743 and 5,356,364, both of which are incorporated herein by reference, in their entirety.

Prior art embossing systems where the embossing pattern is carried directly by one or both of the steel embossing rolls suffer from a number of disadvantages. Specifically, to directly engrave steel can require a significant amount of lead time. Laser engraving of hard rubber has improved the lead time, but has not replaced directly engraved steel rolls due to issues associated with wear. Furthermore, directly engraved steel rolls run the risk that if the emboss pattern gets damaged and a new roll must be produced, the preparation of a new steel roll can require significant time, possibly resulting in machine down time and definitely resulting in increased expense.

The present invention overcomes the disadvantages associated with prior art steel rolls and further addresses the wear issues associated with prior art rubber rolls and sleeves. The present invention provides an embossing roll made from a material that can be patterned and which provides improved wear characteristics. The present invention further provides a resin based roll that is capable of being laser engraved and which exhibits improved wear characteristics and life span in commercial use.

### SUMMARY OF THE INVENTION

In accordance with the invention, there is disclosed a laser engravable embossing roll comprising a resin based material which exhibits improved wear resistance. There is further disclosed a laser engravable embossing roll comprising, a Bisphenol A epoxy based resin, epichlorohydrin and a filler material.

There is still further disclosed, a laser engravable embossing roll comprising a phenolic or styrene based resin that is first patterned and then cured.

Finally, there is disclosed a method of making a patterned web comprising, passing the web between one or more resin based laser engraved embossing rolls.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is an infrared spectrum of one epoxy resin for use according to the present invention.

FIG. 2 is thermogram of one epoxy resin for use according to the present invention.

FIG. 3 is a pyrolysis GC/MS chromatogram of one epoxy resin for use according to the present invention.

FIG. 4 illustrates an emboss pattern that may be used with the present invention.

### DESCRIPTION OF THE EMBODIMENTS

Reference will now be made in detail to the present embodiments (exemplary embodiments) of the invention, an example of which is illustrated in the accompanying drawings.

The present invention relates to the production of rolls for use in the embossing of elongate webs of material, such as paper and the like. More specifically, the present invention relates to embossing rolls that have improved wear resistant surfaces.

The embossing roll according to the present invention can be either formed from a single laser engravable material upon which an embossing pattern is engraved or can be a rigid core that is coated or sleeved with an improved laser engravable material.

One advantage associated with the present invention is the improvements in production time that may be achieved when the embossing pattern is created using laser engraving. As described above, the pattern can be carried directly by a core material that can be laser engraved or can be present in a sleeve or coating of laser engravable material that surrounds a structurally rigid core.

The core may be produced from any art recognized material which can be sleeved or coated with a laser engravable material. Appropriate materials to produce a structurally rigid core will be readily apparent to the skilled artisan. According to one embodiment of the invention, the core would be steel. Appropriate methods for forming a patternable coating or sleeve over a rigid core include any art recognized method and would be readily apparent to the skilled artisan. Preferred coating methods include dip coating, casting or vulcanizing. Appropriate core preparation may include pretreatment to achieve the necessary adherence between the core and the coating. Pretreatments may include, but are not limited to, sandblasting, sanding, and chemical pretreatment.

Materials for use in the production of rolls according to the present invention are selected from resin materials that are capable of being laser engraved, while exhibiting sufficient hardness that they will withstand the ordinary use conditions of commercial embossing. Prior art rubber rolls having a Shore A hardness on the order of 98 can withstand commercial runs conditions for only about 25 days.

Patternable materials that may be used with the present invention include hard resin based materials. Prior art rubber sleeves are generally at about 99 Shore A hardness and below. The material for use according to the present invention exceed the 100 Shore A hardness associated with the scale. Preferably the materials according to the present invention would reside on the Shore D scale. In one embodiment of the present invention, the material has a Shore D hardness of at least about 90.

Preferred materials according to the present invention will not exhibit any substantial wear when used in a standard commercial environment for a least about 3 months, more preferably at least about 6 months, still more preferably at least about 9 months, and most preferably at least about 1 year. The materials according to the present invention can sustain no substantial wear over a 3 to 5 year period. Substantial wear as used in the present invention refers to wear that is at 10 microns or less. Preferred materials according to the present invention will not exhibit wear that is visible to the naked eye at the end of 3, 6, 9 or 12 months from the inception of commercial use.

While resins have not generally been used for embossing rolls, resins provide good durability, good castability, good core adhesion, good printability and good engravability. Appropriate resins would include, but are not limited to, epoxy resins, phenolic resins, isocyanate resins, styrenated resins, polyester resins, thermosetting resins, and polycarbonate resins.

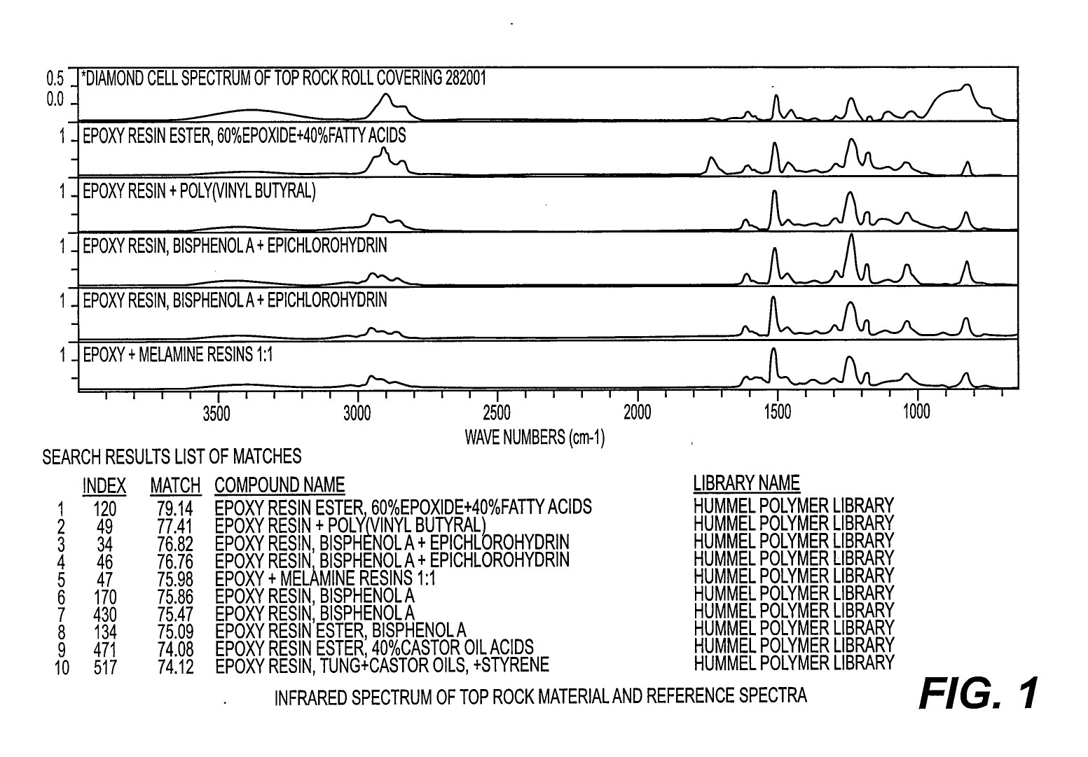

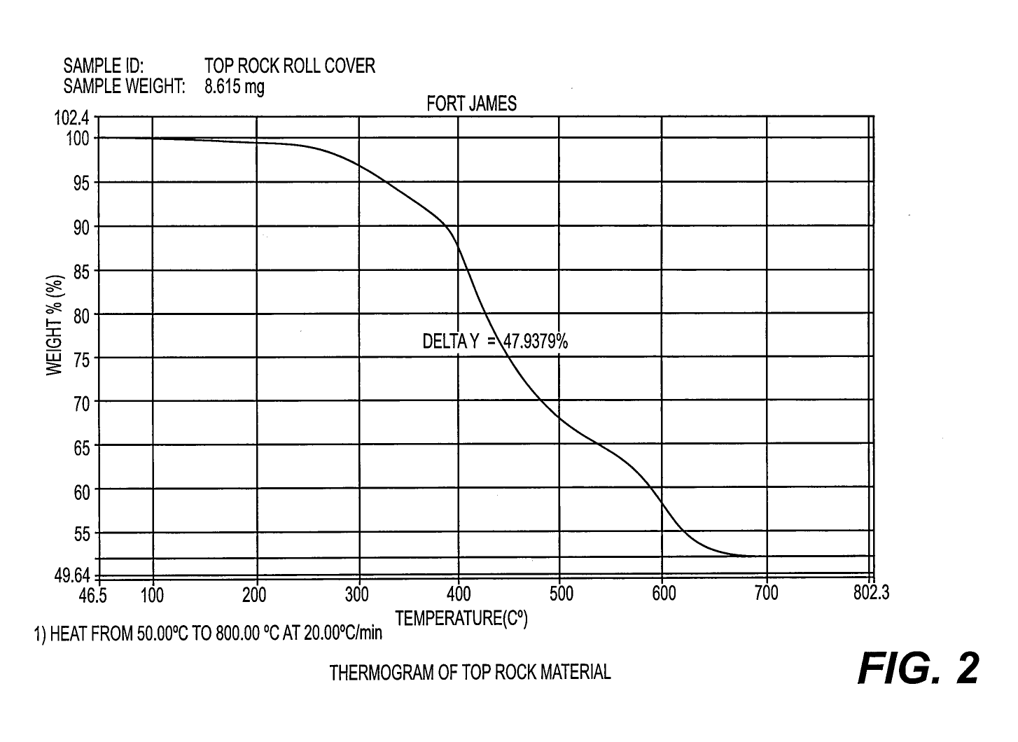

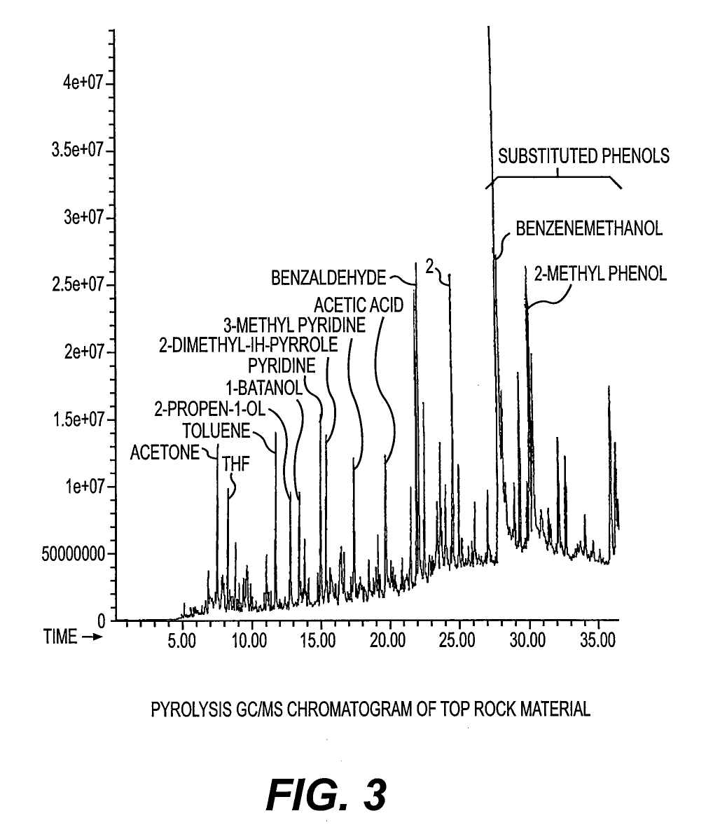

In one embodiment of the present invention, materials for use in the present invention are selected from epoxy based resins, more particularly, epoxy based materials containing Bisphenol A and more preferably containing epichlorohydrin. One preferred material for use according to the present invention has been analyzed and the results of that analysis are set forth in FIGS. 1-3. FIG. 1 is an Infrared spectrum showing that the preferred material according to the present invention is a Bisphenol A type epoxy resin. This preferred material is available from Voith Sulzer under the tradename TOP ROCK. FIG. 2 is a thermogram of the TOP ROCK material between 50° C. and 800° C. The thermogram was used to determine the temperature at which the chromatogram of FIG. 3 was to be carried out. Specifically, this analysis can be used to determine if a material will produce volatiles making it unacceptable for laser engraving. As can be seen from FIG. 3, the most significant volatile produced was benzyl alcohol. In addition, decompositions products as seen in FIG. 3 included acetone, tetrahydrofuran, toluene, 2-propene-1-ol, 1-butanol, pyridine and alkyl substituted pyridines, acetic acid, benzaldehyde and alkyl substituted phenols.

In an alternative embodiment according to the present invention, the resin may be selected from a material which exhibits characteristics making it capable of being laser engraved prior to heat setting or curing. In this embodiment, a soft resin roll may be patterned through laser engraving. The resin is then cured or heat set to result in a hard material capable of withstanding the pressures associated with commercial embossing. Appropriate resins for use according to this embodiment include phenolic resins and isocyanate resins.

Resin materials for use in the present invention may be filled or unfilled materials. The resin may include up to 50% filler, more preferably less than about 40% filler, most preferably less than about 30% filler. Appropriate resins will be readily apparent to the skilled artisan. Filler materials may be selected from any art recognized fillers.

### Example

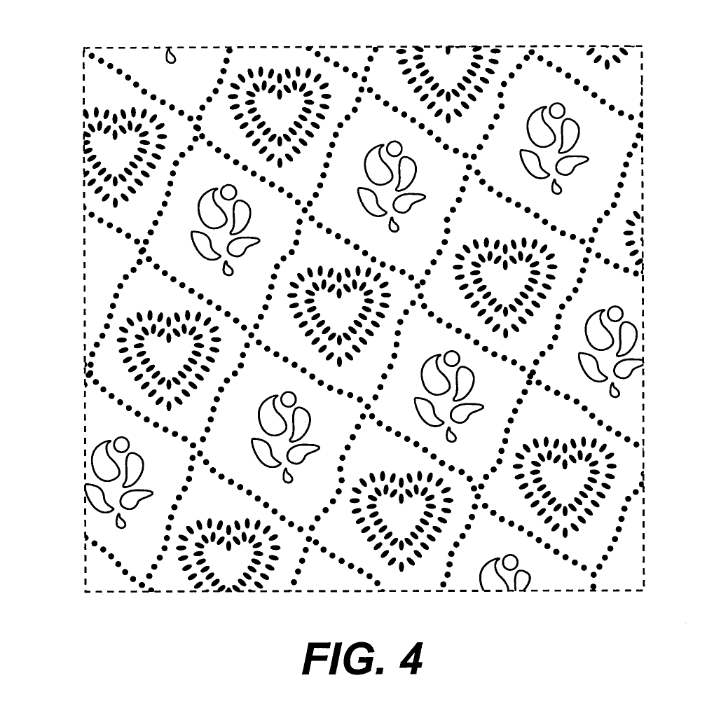

An embossing roll was produced from TOP ROCK material obtained from Voith Sulzer. The TOP ROCK roll was laser engraved using the pattern of FIG. 4. Top Rock exhibits a Shore D hardness of 91.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A laser engravable embossing roll comprising:
a resin material having a Shore A hardness of at least about 100.

2. The embossing roll of claim 1, wherein the resin material has a Shore D hardness of at least about 90.

3. The embossing roll of claim 1, wherein the resin is chosen from at least one of epoxy resins, phenolic resins, isocyanate resins, styrenated resins, polyester resins, thermosetting resins and polycarbonate resins.

4. The embossing roll of claim 3, wherein the resin material is chosen from at least one epoxy resin.

5. The embossing roll of claim 4, wherein the epoxy resin is a Bisphenol A resin.

6. The embossing roll of claim 5, further comprising epichlorohydrin.

7. The embossing roll of claim 6, further comprising a filler.

8. The embossing roll of claim 7, wherein the filler is present in an amount of less than about 50%.

9. The embossing roll of claim 8, wherein the filler is present in an amount of less than about 30%.

10. The embossing roll of claim 1, wherein the resin material forms both the roll surface and the roll core.

11. The embossing roll of claim 1, wherein the resin material forms the roll surface and wherein the roll contains a rigid core of another material.

12. The embossing roll of claim 11, wherein the core is steel.

13. A laser engravable embossing roll comprising:
a Bisphenol A epoxy based resin,
epichlorohydrin, and
a filler material.

14. The embossing roll of claim 13, further comprising a steel core.

15. A method of producing a laser engraved embossing roll comprising:
providing a roll having a surface of a laser engravable resin material which will provide a Shore A hardness of greater than 100 for the final roll;
laser engraving the resin material to establish an embossing pattern in the surface.

16. The method according to claim 15, wherein the final roll has a Shore D hardness of at least 90.

17. The method according to claim 15, further comprising heat setting or curing the resin material after the embossing pattern has been established.

18. The method according to claim 16, further comprising heat setting or curing the resin material after the embossing pattern has been established.

19. The method of claim 15, wherein the resin surface is formed over a steel core.

20. The method of claim 19, wherein the resin surface is produced by dip coating, casting or vulcanizing.

21. The method of claim 19, wherein the steel core is treated by one or more of sandblasting, sanding or chemical pretreatment prior to providing the resin surface over the core.

22. The method according to claim 15, wherein the resin is chosen from at least one of epoxy resins, phenolic resins, isocyanate resins, styrenated resins, polyester resins, thermosetting resins and polycarbonate resins.

23. The method according to claim 16, wherein the resin material is chosen from at least one epoxy resin.

24. The method according to claim 17, wherein the epoxy resin is a Bisphenol A resin.

25. The method according to claim 18, further comprising epichlorohydrin.

26. The method according to claim 19, further comprising a filler.

27. The method according to claim 20, wherein the filler is present in an amount of less than about 50%.

28. The method according to claim 21, wherein the filler is present in an amount of less than about 30%.
